(19) United States
(12) Patent Application Publication
(10) Pub. No.: US 2013/0014424 A1
(43) Pub. Date: Jan. 17, 2013

(54) Fishing Device

(71) Applicant: Larry Weishner, Irving, TX (US)

(72) Inventor: Larry Weishner, Irving, TX (US)

(21) Appl. No.: 13/184,394

(22) Filed: Jul. 15, 2011

(51) Int. Cl. A01K 97/00

(52) U.S. Cl. 43/17.5

(57) ABSTRACT

A fishing device may include a base section to magnetically connect to a support surface, a middle section being connected to the base section and including a light source to emit light and a top section being connected to the middle section reflecting the light through a inclined wall of the top section. The top section may include a pair of opposing arms to hold fish scent. The light source may be a flashlight.

### FIELD OF THE INVENTION

The present invention relates to fishing apparatus and more particularly to a fishing device which may include a scent dispensing device, a light, a spool for fishing line, and a submersible device.

### BACKGROUND

Fishing is a great pastime, and there is a need for a device which may dispense scent, act as a light or beacon and be submersible.

U.S. Pat. No. 4,884,355 discloses a fishing bobber in the form of a floatable container or jug and including a visual signal selectively actuated upon the taking of a baited hook on a line by a fish. The bobber contains a power source and circuitry including an electrically conductive plunger operable by fishing line movement.

U.S. Pat. No. 6,854,207 discloses a fishing line spool with different sizes of female threads for removably attaching to a threaded neck of a plastic bottle to create a jug line used for jug fishing. The spool is removed from the bottle for storage. The spool is provided with a line spool area around which fishing line is wrapped to store the line and with a double walled protection flange provided with penetrable material to receive the pointed end of hooks when the fishing line is not in use. A locking pin removably extends through pin openings provided on either side of the spool area to prevent fishing line from unwinding from the thread spool area and as a means of fixing the depth of the fishing line. The locking pin can be removed from the pin openings to allow the fishing line to be wrapped onto or unwrapped from the spool area.

### SUMMARY

A fishing device may include a base section to magnetically connect to a support surface, a middle section being connected to the base section and including a light source to emit light and a top section being connected to the middle section reflecting the light through a inclined wall of the top section.

The top section may include a pair of opposing arms to hold fish scent.

The light source may be a flashlight.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the fishing device of the present invention;

FIG. 2 illustrates another cross-sectional view of the fishing device of the present invention;

FIG. 3 illustrates a bottom view of the fishing device of the present invention;

FIG. 4 illustrates a top view of the fishing device of the present invention

### DETAILED DESCRIPTION

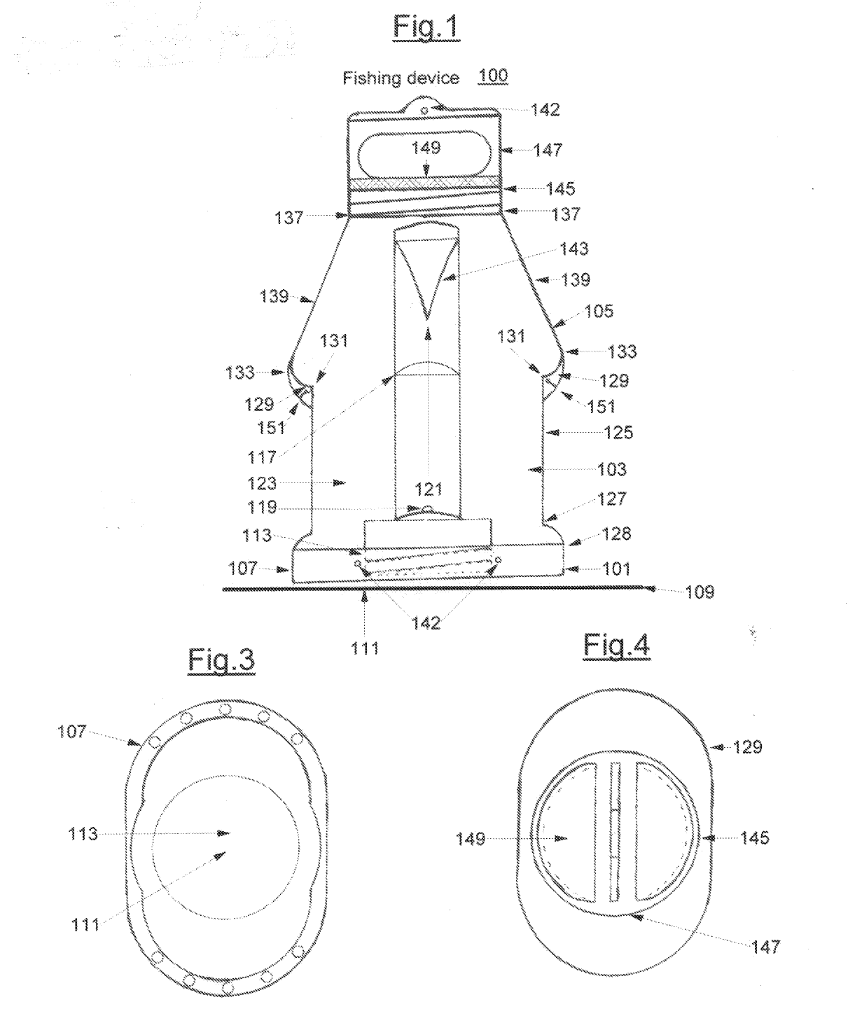

FIG. 1 illustrates a cross-sectional view of the fishing device 100 which may include a base section 101, a middle section 103 and a top section 105. The base section 101, the middle section 103 and the top section 105 may each be oval-shaped, circular shape, rectangular shape or other appropriate shape. The sections could be formed from metal, plastic, wood or other appropriate material. The middle section 103 and the top section 105 may be hollow or partially hollow.

The base section 101 may include a downward extending oval-shaped wall 107 which may include embedded magnetic material or could be magnetized metal in order to be magnetically attached to a support surface 109 which could be the water, a boat, a vehicle, the ground, a structure or any other type of support surface 109. The base section 101 may include a central aperture 111 which may extend through the base section 101 and may be waterproof sealed with a removable and replaceable cap 113 which may threadably engage the interior wall 115 of the middle section 103. The interior wall 115 may extend through the aperture 111 and may be a cylinder in shape. The distal end of the interior wall 115 may be connected to a magnifying prism or focusing glass 117 to magnify the light 121 which may emit from the light source 119 which may be a flashlight, LED light or other appropriate light which is positioned within the interior wall 115. The focusing glass 117 may be waterproof sealed to the interior wall 115 so that water which may enter the cavity 123 does not penetrate the interior of the focusing glass 117 and the interior wall 115.

The middle section 103 may include an exterior wall 125 which may extend between the 101 and the top section 105 and may extend around the middle section 103 and may be substantially oval in shape. The exterior wall 125 may be connected to the top surface 128 of the base section 101 may define a first shoulder 127 to allow fishing line to be wrapped around the exterior wall 125 and to prevent the fishing line from extending beyond the exterior wall 125.

The exterior walls 115 may extend substantially horizontally to and be connected to the bottom wall 129 of the top section 105 and may define a second shoulder 131 to prevent the fishing line from extending beyond the exterior wall 125. The bottom wall 129 may extend around the periphery of the top section 105. The bottom wall 129 may be connected to a horizontal wall 133 which may extend around the periphery of the top section 105 and may be connected to an inclined wall 139 which may be at an acute angle to the horizontal wall 137 and may extend around the periphery of the top section 105. A pair of opposed attachment walls 141 may extend out of the inclined wall 139 and may include an aperture 142 to be used to cooperate with a rope or string to secure the fishing device 100.

The inclined wall 139 may be formed from transparent or translucent material in order that the reflected light 121 which may be reflected from the interior reflective surface 143 of the removable and replaceable top cap 145 which may be threadably connected to the inclined surface 139 of the top section 105 to form a substantially waterproof seal with the top section 105. The top cap 145 may be opened to allow water or other types of weight to enter the cavity 123 of the middle section 103 and the top section 105 to allow the fishing device 100 to float, partially submerged or fully submerged.

A handle 147 may be connected to the top cap 145 and may be substantially U-shaped to carry the fishing device 100 and may include a pair of opposing arms 149 and which may hold fish scent to attract fish.

A line retainer 151 may be connected to the fishing device 100 to attach a fishing line in order to catch fish.

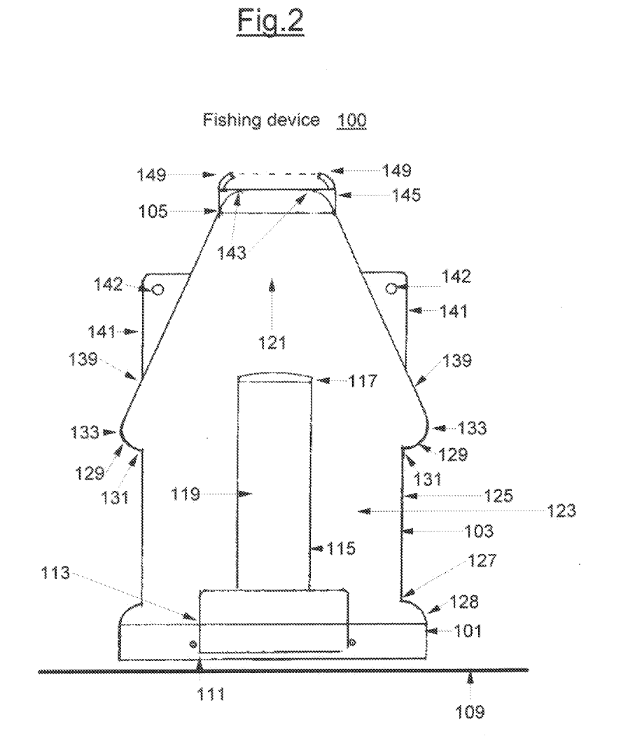

FIG. 2 illustrates a cross-sectional view of another embodiment of the fishing device 100 which may include a base section 101, a middle section 103 and a top section 105. The base section 101, the middle section 103 and the top section 105 may each be oval-shaped, circular shape, rectangular shape or other appropriate shape. The sections could be formed from metal, plastic, wood or other appropriate material. The middle section 103 and the top section 105 may be hollow or partially hollow.

The base section 101 may include a downward extending oval-shaped wall 107 which may include embedded magnetic material or could be magnetized metal in order to be magnetically attached to a support surface 109 which could be the water, a boat, a vehicle, the ground, a structure or any other type of support surface 109. The base section 101 may include a central aperture 111 which may extend through the base section 101 and may be waterproof sealed with a removable and replaceable cap 113 which may threadably engage the interior wall 115 of the middle section 103. The interior wall 115 may extend through the aperture 111 and may be a cylinder in shape. The distal end of the interior wall 115 may be connected to a magnifying prism or focusing glass 117 to magnify the light 121 which may emit from the light source 119 which may be a flashlight, LED light or other appropriate light which is positioned within the interior wall 115. The focusing glass 117 may be waterproof sealed to the interior wall 115 so that water which may enter the cavity 123 does not penetrate the interior of the focusing glass 117 and the interior wall 115.

The middle section 103 may include an exterior wall 125 which may extend between the 101 and the top section 105 and may be substantially oval in shape and extend around the metal section 103. The exterior wall 125 may be connected to the top surface 128 of the base section 101 may define a first shoulder 127 to allow fishing line to be wrapped around the exterior wall 125 and to prevent the fishing line from extending beyond the exterior wall 125.

The exterior walls 125 may extend substantially horizontally to and be connected to the bottom wall 129 of the top section 105 and may define a second shoulder 131 to prevent the fishing line from extending beyond the exterior wall 125. The bottom wall 129 may extend around the periphery of the top section 105. The bottom wall 129 may be connected to a horizontal wall 133 which may extend around the periphery of the top section 105 and may be connected to an inclined wall 139 which may be at an acute angle to the horizontal wall 137 and may extend around the periphery of the top section 105. A pair of opposed attachment walls 141 may extend out of the inclined wall 139 and may include an aperture 142 to be used to cooperate with a rope or string to secure the fishing device 100.

The inclined wall 139 may be formed from transparent or translucent material in order that the reflected light 121 which may be reflected from the interior reflective surface 143 of the removable and replaceable top cap 145 which may be threadably connected to the inclined surface 139 of the top section 105 to form a substantially waterproof seal with the top section 105. The top cap 145 may be opened to allow water or other types of weight to enter the cavity 123 of the middle section 103 and the top section 105 to allow the fishing device 100 to float, partially submerged or fully submerged.

A pair of opposing arms 149 may be connected to the top cap 145 and may hold fish scent to attract fish.

A line retainer 151 may be connected to the fishing device 100 to attach a fishing line in order to catch fish.

FIG. 3 illustrates a bottom view of the fish device and illustrates the wall 107, the central aperture 111 and the cap 113.

FIG. 4 illustrates a top view of the fish device 100 and illustrates the handle 147, the focusing glass 117, the attachment wall 141 and the bottom wall 129.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A fishing device, comprising:
a base section to magnetically connect to a support surface;
a middle section being connected to the base section and including a light source to emit light;
a top section being connected to the middle section reflecting the light through a inclined wall of the top section.

2) A fishing device as in claim 1, wherein the top section includes a pair of opposing arms to hold fish scent.

3) A fishing device as in claim 1, wherein the light source is a flashlight.
